(19) United States
(12) Patent Application Publication
(10) Pub. No.: US 2009/0314559 A1
(43) Pub. Date: Dec. 24, 2009

(54) ENGINE UNIT WITH START-STOP CONTROL FOR A MOTOR VEHICLE

(75) Inventor: Mauro Palitto, Collegno (IT)

Correspondence Address: BLACK LOWE & GRAHAM, PLLC, 701 FIFTH AVENUE, SUITE 4800, SEATTLE, WA, 98104, US

(73) Assignee: PROTOTIPO S.p.A., Trofarello (IT)

(21) Appl. No.: 11/919,574

(22) PCT Filed: Apr. 28, 2006
(86) PCT No.: PCT/IB2006/001038

§ 371 Date: May 26, 2009

(51) Int. Cl. B60W 10/04; B60K 6/42; G06F 19/00; B60W 20/00

(52) U.S. Cl. 180/65.22; 701/22; 477/3; 180/65.21

(57) ABSTRACT

Described herein is an engine unit (1) with start-stop control for a motor vehicle, comprising: - an engine set (2), which has: a first internal-combustion engine (8) having an output shaft, which can turn about a first axis (A); a first servo clutch (9) rigidly connected to the output shaft of the first internal-combustion engine (8); and a speed change (10) having a primary shaft connected to the first clutch (9) and to the wheels of the motor vehicle; - a set of accessories (4), driven by at least one driving shaft (14), which can turn about a second axis (C; B), and comprising at least one accessory from among: a compressor for an air-conditioning system (5), a vacuum pump for a servo-braking system, and a pump for a servo-steering system; - an electric machine (6); - a transmission unit (7) for connecting together the first internal-combustion engine (8), the set of accessories (4), the electric machine (6), and a connecting portion (12), which is integral with the primary shaft of the first speed change (10) in order to enable driving of the set of accessories (4) and of the electric machine (6) by the wheels of the motor vehicle.

### TECHNICAL FIELD

The present invention relates to an engine unit with start-stop control for a motor vehicle.

### BACKGROUND ART

An engine unit for a motor vehicle generally comprises an internal-combustion engine and a multiplicity of accessories, which are connected to a drive shaft of the engine via a transmission and are designed, for example, to drive respective on-board systems, such as, for example, the electrical equipment or the air-conditioning system.

In order to reduce the energy consumption and pollutant emission of motor vehicles to a minimum, motor vehicles have been provided which are equipped with a start-stop control that enables the engine unit to be turned off during stops made by the motor vehicle when circulating, for example, when the vehicle stops at traffic lights.

### DISCLOSURE OF INVENTION

The aim of the present invention is to provide an engine unit equipped with a start-stop control, said engine unit enabling a further reduction in energy consumption, presenting contained costs, and having reduced overall dimensions.

According to the present invention, an engine unit is provided equipped with a start-stop control for a motor vehicle, as defined in claim 1.

### BRIEF DESCRIPTION OF THE DRAWINGS

For a better understanding of the present invention, a preferred embodiment is now described, which preferably comprises also a second engine on the hypothesis of its used in a motor vehicle in which a pump for a servo-steering system and a vacuum pump for the servo brake are electrically actuated. The ensuing description is provided purely by way of non-limiting example and with reference to the attached drawings, wherein:

FIG. 1 is a diagram of an engine unit according to the present invention;

FIG. 2 is a system diagram of the engine unit of FIG. 1;

FIG. 3 is a perspective view of a second embodiment of the present invention;

FIG. 4 is a cross section of a detail of the engine unit of FIG. 3 according to the line IV-IV of FIG. 3; and

FIGS. 5 and 6 are diagrams of respective further embodiments of the present invention.

### BEST MODE FOR CARRYING OUT THE INVENTION

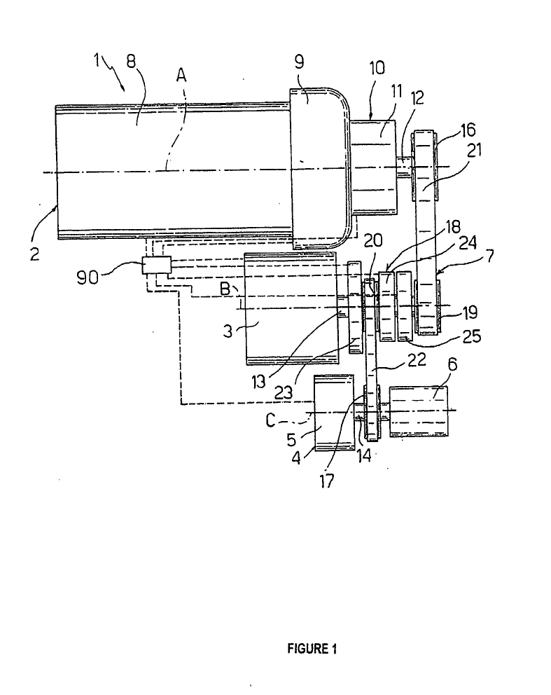

Designated, as a whole, by 1 in FIG. 1 is an engine unit for a motor vehicle, comprising: a transverse internal-combustion engine set 2 for front wheel drive which is substantially the same as a standard production engine; a second internal-combustion engine 3; a set of accessories 4, which comprises a compressor 5 for an air-conditioning system and a reversible electric machine 6; and a transmission unit 7 for connecting the engine set 2, the second internal-combustion engine 3, and the set of accessories 4 to the wheels and to one another.

The compressor 5 is of a known type with a de-activatable impeller or equivalent type, and the reversible electric machine 6 has a reduced power, it being sized for charging a battery (not illustrated) of on-board electrical equipment and for supplying the power necessary for starting the second engine 3. In particular, the reversible electric machine 6 and the battery define an ensemble for partial recovery of the kinetic energy of the motor vehicle, for example during braking.

The engine set 2 comprises: a first internal-combustion engine 8 having an engine displacement that is higher, for example four times higher, than that of the second engine 3; a servo clutch 9, which is mounted on a front wall of the internal-combustion engine 8 and is coupled to a crankshaft (not shown) of the internal-combustion engine 8 perpendicular to the front wall; and a speed change 10 of any type, either manual or automatic, for example robotized with discrete gear ratios, which is controlled by an electronic control unit 90. The speed change 10 is connected to the clutch 9 so as to enable decoupling thereof from the internal-combustion engine 8 and has discrete transmission ratios sized according to the characteristic of torque of the internal-combustion engine 8.

In particular, the speed change 10 comprises: an outer casing 11, a primary shaft, which can turn about an axis A common to the crankshaft of the internal-combustion engine 8 and is directly connected to the crankshaft when the clutch 9 is engaged; a secondary shaft, which is connected to the wheels of the vehicle and has gears that couple with the primary shaft for defining the discrete transmission ratios; and an end portion 12, which is integral with the primary shaft and comes out of the casing 11 on the opposite side with respect to the clutch 9.

The second engine 3 is arranged laterally with respect to the engine set 2 and has a crankshaft 13, which can turn about an axis B parallel to the axis A. The compressor 5 and the reversible electric machine 6 are connected on axially opposite sides of a driving shaft 14, which can turn about an axis C parallel to the axis B.

The transmission unit 7 comprises: outer pulleys 16, 17, which are connected, respectively, to the end portion 12 and to the driving shaft 14; and a decoupling assembly 18, which is rotationally connected to the crankshaft 13 and has respective transmission pulleys 19, 20, which share the same axis B and are connected via respective belts 21, 22 to the peripheral pulleys 16, 17.

The decoupling assembly 18 further comprises in rotational connection about the axis B, to form a single module: a servo clutch 23, set between the crankshaft 13 and the transmission pulley 20; an electromagnetic coupling 24, connected to the transmission pulley 20 on the opposite side with respect to the servo clutch 23; and an epicyclic reduction gear 25 with two speed ratios, connected to the electromagnetic coupling 24 on one side and to the transmission pulley 19 on the other.

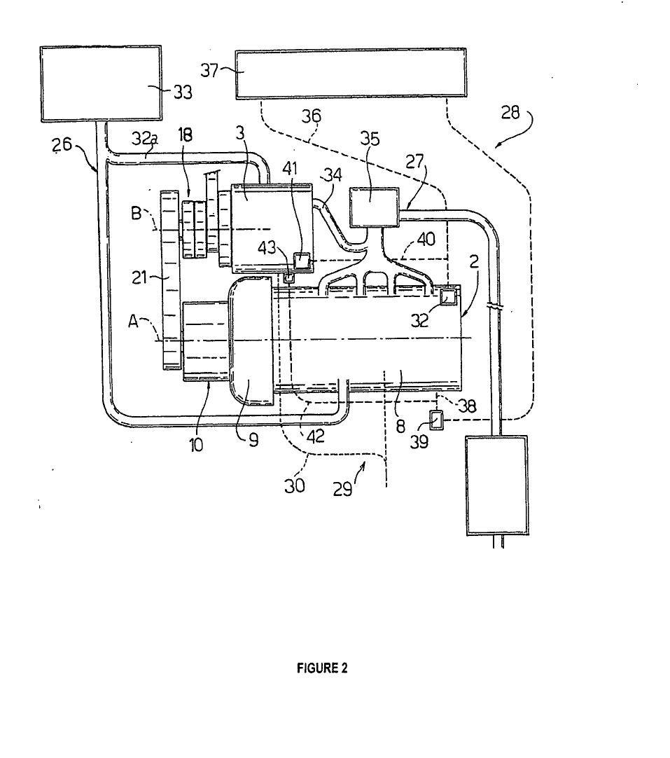

The engine set 2 adopts the traditional circuits of a single-engine vehicle. In fact, the internal-combustion engine 8 is connected to corresponding circuits for intake 26, exhaust 27, cooling 28, and supply 29 (FIG. 2) of a traditional type, and the second engine 3 is branched to the same circuits. In particular, the second engine 3 is connected to the intake circuit 26 via a supplementary pipe 32a set branching downstream of an air filter 33 of the intake circuit 26 itself; is connected to the exhaust circuit 27 via a supplementary exhaust pipe 34 set upstream of a catalytic converter 35 of the exhaust circuit 27 itself, and is connected to the supply circuit 29 via a supplementary piping 30, which is set downstream of a fuel pump (not illustrated) of the supply circuit 29 connected to a tank (not illustrated).

The cooling circuit 28 comprises: an inlet line 36 provided with a pump 32 for conveying the refrigerating fluid from a radiator 37 to the internal-combustion engine 8; and an outlet line 38 provided with a thermostat 39 for conveying the refrigerating fluid at outlet from the internal-combustion engine 8 to the radiator 37.

The second engine 3 is moreover connected to the cooling circuit 28 via a branching line 40, which is inserted in the inlet line 36 upstream of the pump 32 and is, in turn, provided with a pump 41. The internal-combustion engine 3 is moreover connected to the outlet line 38 upstream of the thermostat 39 via a pipe 42 provided with a thermostat 43 set at outlet from the second internal-combustion engine 3.

In use, the clutches 9, 23, the electromagnetic coupling 24, the speed change 10, and the epicyclic reduction gear 25 are controlled automatically by the electronic control unit 90, which receives inputs from: the accelerator pedal, the brake pedal, the gear control, the speedometer sensor, the battery-charge sensor, the air-conditioning system, the braking system, the servo-steering system, the exhaust circuit, and the cooling circuit. The electronic control unit 90 enables propulsion of the motor vehicle either in a single-engine mode, i.e., using only the internal-combustion engine 8, by closing the clutch 9 and opening the electromagnetic coupling 24, or alternatively using only the second engine 3, by opening the clutch 9 and closing the electromagnetic coupling 24 and the servo clutch 23, or else in a combined-engine mode, i.e., by closing the electromagnetic coupling 24 and the clutches 9, 23 and acting on the epicyclic reduction gear 25 in order to use the second engine 3 in conditions of high efficiency compatible with the maximum r.p.m. thereof.

In particular, the epicyclic reduction gear 25 has at least one long reduction ratio and one short reduction ratio defined in such a way that, given the same r.p.m. at input from the crankshaft 13, an r.p.m. at output from the pulley 19 is smaller when the short ratio is selected as compared to what can be obtained by selecting the long ratio.

In use, via the servo clutch 23 and the electromagnetic coupling 24, the set of accessories 4 can be either connected to or disconnected from the second engine 3 or else the internal-combustion engine 8 or else directly the wheels of the vehicle. When the accelerator is released with the vehicle still in motion, the engines 3 and 8 are stationary and are disconnected from the transmission by intervention of the electronic control unit 90. If also the set of accessories 4 is stationary and disconnected from the transmission, freewheeling is obtained. If it is necessary for some accessory to be actuated, the set of accessories 4 is activated by the transmission unit 7 by closing the electromagnetic coupling 24 and is consequently driven using the kinetic energy of the vehicle. In addition, the absorption of kinetic energy can be adjusted using the ratios of the epicyclic reduction gear 25 and of the speed change 10. For example, it is possible to use the short ratio for driving the set of accessories 4 when the speed of the vehicle is low and the long ratio when the speed of the vehicle is high, in order to maintain, as the speed of the motor vehicle varies, the speed for driving the set of accessories 4 at the maximum possible value but always smaller than the maximum r.p.m. allowed for the accessories.

In addition, when the vehicle is travelling, the ratios of the epicyclic reduction gear 25 are selected by the electronic control unit 90 to enable the best efficiency of the internal-combustion engine 3 both when said engine 3 operates alone and when it operates in conjunction with the internal-combustion engine 8.

With the vehicle stationary, the engines 3 and 8 are turned off, but in the case where operation of some accessory is required, the electromagnetic coupling 24 is opened and only the second engine 3 remains on.

At the start of a trip, in a step of initial ignition of the engine unit 1, the second engine 3 is started via the reversible electric machine 6 activated by the driver using an ignition key or equivalent system, whilst the gear 10 is in neutral and the short ratio of the epicyclic reduction gear 25 is selected; re-starting within one and the same trip is activated by the electronic control unit 90.

During pickup of the motor vehicle following upon the ignition step, the following situations may arise:

a. when the performance required, which can be determined by the position of the accelerator, can be achieved with the power that can be supplied by the second engine 3, pickup of the motor vehicle is obtained with the second engine 3 alone, since the epicyclic reduction gear 25 is in the shorter ratio;

b. when the level of performance required exceeds the one that can be obtained with the second engine 3, also the internal-combustion engine 8 is activated, which is started via the transmission unit 7 by closing the clutch 9 after a brief displacement of the motor vehicle;

c. if the acceleration requirement is maximum with the vehicle stationary (kickdown), the two engines 3, 8 are set in motion according to the following fast sequence: first the internal-combustion engine 3 is set in motion, then the internal-combustion engine 8 by closing the clutch 9 when the gear 10 is still in neutral, then the car is started by closing the two clutches 9, 23; this fast starting sequence can be carried out also using a slope sensor; in addition, in order to control the fast sequence of starting of the engines 3, 8 irrespective of the slope sensor and of kickdown, a starting pushbutton is provided on the steering wheel, which can be operated by the driver.

When the motor vehicle is travelling, the following alternative situations may arise:

a. when the performance required can be achieved by the power that can be supplied by the second engine 3 alone, the clutch 9 is opened and the internal-combustion engine 8 is turned off; in this step, when a ratio of the speed change 10 is selected, the clutch 23 is opened to enable engagement of the ratio, then the clutch 23 is reclosed, and the electronic control unit 90 selects first the short ratio and next the long one of the epicyclic reduction gear 25 according to the r.p.m. of the end portion 12; when the second engine 3 is active, the set of accessories 4 is always driven;

b. when the performance required exceeds the one that can be achieved with the second engine 3 and can be achieved by the internal-combustion engine 8 alone, this is started by closing the clutch 9 when the second engine 3 is still in motion; the second engine 3 is then turned off and disconnected through the clutch 23 as soon as the internal-combustion engine 8 is started; in this condition of operation, the set of accessories can be coupled via the electromagnetic coupling 24; in this step, when a ratio of the speed change 10 is selected, the clutch 9 is opened to enable engagement of the ratio, and then the clutch 9 is reclosed;

c. in the case where the maximum torque is required, the engines 3, 8 are coupled together, and the ratios of the epicyclic reduction gear 25 are controlled as described previously preventing the second engine 3 from exceeding its own maximum r.p.m.; the compressor 5 is moreover disengaged, and the reversible electric machine 6 is activated as engine for a few seconds; in this step, when a ratio of the speed change 10 is selected, both of the clutches 9 and 23 are opened to enable engagement of the gear ratio, and then both of the clutches 9 and 23 are reclosed.

In a step where the accelerator is released, for example when travelling downhill or else during a deceleration without operating the brakes, the engines 3, 8, if active, upon command by the electronic control unit 90, are turned off and disconnected by opening the clutches 9 and 23. Also the set of accessories 4 can be disconnected if its operation is not necessary, in order to maximize smooth running of the motor vehicle, or else can be driven directly by the wheels via the speed change 10. In this case, the electronic control unit 90 automatically selects the ratios of the speed change 10 and of the epicyclic reduction gear 25 as described previously to maintain the r.p.m. of the set of accessories 4 at a high level. In this way, it is possible to recover directly the kinetic energy of the motor vehicle, using it to drive the set of accessories 4. Next, in a step in which the accelerator is pressed and the vehicle is still in motion, the engines 3, 8 can be turned on via the transmission unit 7 using the inertia of the motor vehicle.

In a step of deceleration in which the accelerator is released and braking is required, according to the deceleration required, the set of accessories 4 and the engines 3 and 8 are engaged in sequence, and finally the brakes are activated.

At a stop, the engines 3, 8 are turned off, and the second engine 3 remains on only in the case where it is necessary to activate the set of accessories 4. In addition, if the battery is sufficiently charged, also the second engine 3 can be turned off, and the compressor 5 can be actuated by the reversible electric machine 6, keeping the clutch 23 and the electromagnetic coupling 24 open.

During pickup of the motor vehicle after a stop within one and the same trip, operation is similar to that of initial starting of the motor vehicle, but ignition of the second engine 3 is activated by the electronic control unit 90 at the moment when the manoeuvre of engagement of the shortest ratio of the speed change 10 is started. In addition, during a stop with the gear in neutral in which the set of accessories 4 is driven by the second engine 3, when the shortest ratio of the speed change 10 is selected, the internal-combustion engine 8 is started via the second engine 3, by closing the clutch 9, and then the clutch 9 is opened for engaging the shortest ratio of the speed change 10 and enabling pickup of the motor vehicle following upon operation of the accelerator pedal. After pickup of the motor vehicle, if the performance required can be achieved with just the second engine 3, the internal-combustion engine 8 is immediately disconnected and turned off.

During reverse, the internal-combustion engine 8 that will be used also for pickup of the motor vehicle to move forwards immediately following upon reverse is once again used so as to simplify operations when manoeuvring.

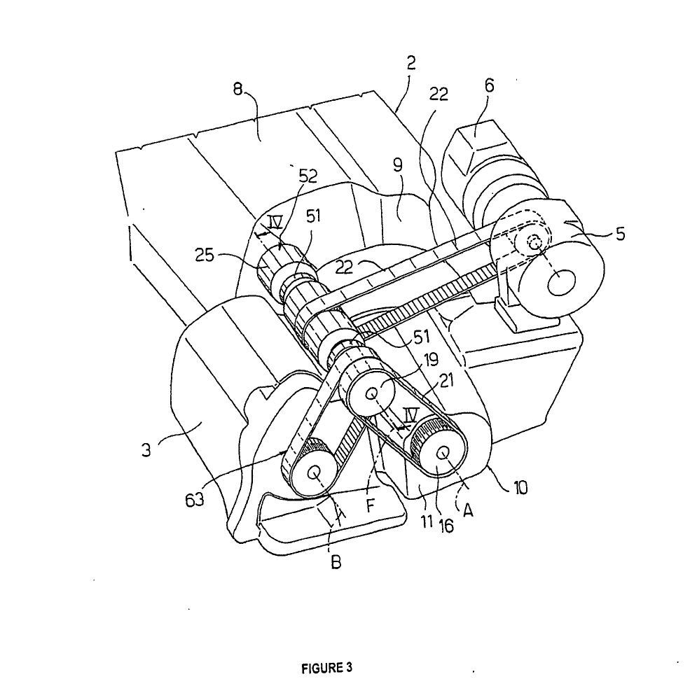

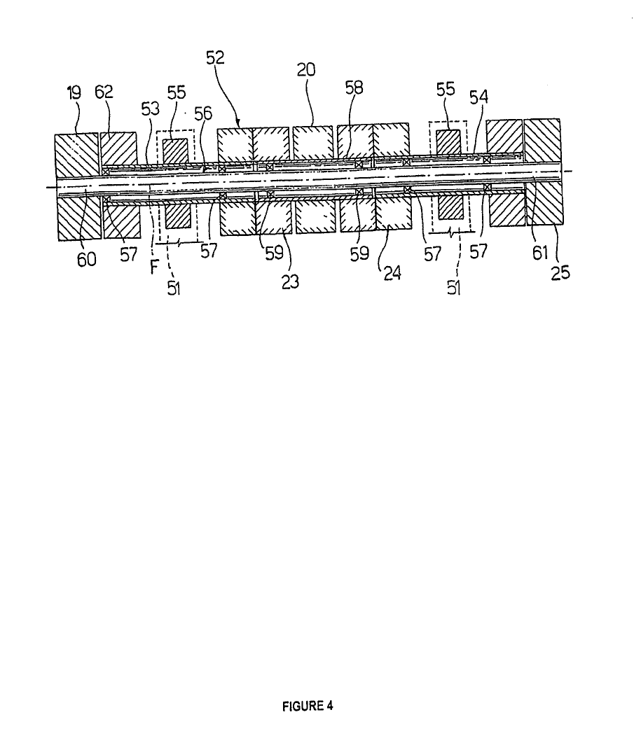

FIGS. 3 and 4 illustrate a second embodiment in which the decoupling assembly 18 is replaced by a transmission 52 (see FIGS. 3 and 4, in which elements that are functionally similar to the ones of the engine unit 1 are designated by the same reference numbers).

In this particular case, the transmission 52 is able to turn about an axis F located above the speed change 10 and the second engine 3 and comprises: a first side sleeve 53 and a second side sleeve 54, which are set at a distance from one another along the axis F parallel to the axis A and are supported so that they can turn, via bearings 55, by supporting brackets 51 constrained to the casing 11 of the speed change 10; a shaft 56 housed so that it can turn within the sleeves 53, 54 via bearings 57; and a central sleeve 58, which is set between the sleeves 53, 54 and is supported, so that it can turn, by the shaft 56 via bearings 59.

In particular, the shaft 56 integrally comprises end portions 60, 61, which are opposite to one another and project axially from the respective sleeves 53, 54. The end portion 60 is rigidly connected to the transmission pulley 19 for connection with the pulley 16 and the engine set 2, and the end portion 61 is rotationally connected to the sleeve 54 via the epicyclic reduction gear 25.

The sleeve 53 is fixed to a driving pulley 62 connected via a belt drive 63 to the crankshaft 13 of the second engine 3. The central sleeve 58 is fixed to the transmission pulley 20 for connection to the set of accessories 4.

In addition, the central sleeve 58 is rotationally connected to the sleeves 53, 54 via the servo clutch 23 and the electromagnetic coupling 24, respectively, which are set on opposite sides with respect to the transmission pulley 20. Alternatively, the central sleeve 58 is directly connected to the pulley 62, and the clutch 23 is directly connected to the crankshaft 13 with which it shares the axis B.

The transmission 52 thus provided presents contained overall dimensions and, thanks to the belt drive 63, enables adaptation to the internal layout of the engine compartment.

From an examination of the characteristics of the engine unit 1 provided according to the present invention, the advantages that this makes possible are evident.

The set of accessories 4 can be connected directly to the primary of the speed change 10 via the transmission unit 7 and can consequently be actuated by the wheels of the motor vehicle also in the step of release of the accelerator when both of the engines 3, 8 are decoupled from the transmission unit 7 and turned off by intervention of the electronic control unit 90. In this way, the overall levels of efficiency improve because turning off of the internal-combustion engines can be extended to all the steps of release of the accelerator when the motor vehicle is travelling, without jeopardizing the various functions, which depend upon the accessories, the latter being actuated using the kinetic energy of the motor vehicle.

The fact that, when the clutch 9 is closed, the primary shaft of the speed change 10 is rigidly coupled to the drive shaft of the internal-combustion engine 8 enables the engine set 2 to be configured as an engine of a standard-production type, and consequently one that is available at low costs. In addition, provision of the end portion 12 enables modification of the speed change 10 in a simple and inexpensive way, in particular in the case of a manual or robotized speed change.

The transmission unit 7, comprising the two belts 21, 22, which are connected to the axes A and C, respectively, and can be coupled to one another by means of the electromagnetic coupling 24 so that they share a common axis, the axis B or the axis F, enables engagement of the set of accessories 4 only when energy saving is required. Furthermore, the transmission unit 7 defines an inexpensive structure, which can be adapted in a simple way to different configurations with start-stop control that enable maximization of the steps of stop and direct driving, via the wheels, of the accessories when this is necessary, so enabling a good recovery of the kinetic energy in the steps of deceleration. In the example illustrated, a second internal-combustion engine 3 is used having a power such as to enable propulsion of the vehicle in many urban-traffic situations. Alternatively, the second engine 3 can comprise a reversible electric machine having a power lower than or equal to that of the first internal-combustion engine 8. In the deceleration steps, it is consequently possible to increase further the amount of electrical recovery of the kinetic energy not used in driving of the set of accessories 4. In this case, the reversible electric machine is not present among the accessories. According to a possible further configuration, the engine unit 1 comprises a single internal-combustion engine 8. In this case, the set of accessories 4 can be connected to the electromagnetic coupling 24 according different modalities. For example, the set of accessories 4 can be connected coaxially to the electromagnetic coupling 24 without envisaging the axis C, or else it can be connected so that it shares either the axis B or the axis C, at the same time enabling decoupling and free-wheeling. In addition, it is possible to envisage further axes parallel to the axis C in order to drive accessories that turn about the axis B, for example via respective belt transmissions, between the pulley 20 and the electromagnetic coupling 24 for enabling decoupling.

Both in the case where the engine unit 1 comprises a single internal-combustion engine 8 and in the case where it comprises both of the internal-combustion engines 3 and 8, the electric machine connected to the transmission unit 7 can have small overall dimensions and a limited power, for example, of approximately 2 kW, and thus perform the functions of: starting of the internal-combustion engine 3 or 8; driving of the set of accessories 4 when the motor vehicle stops; and propulsion when carrying out minor manoeuvres, such as, for example, when moving ahead in a queue. In addition, via the pulley 20 or the driving shaft 14, a power takeoff is made available for any possible further accessories in addition to the ones described so far, such as an accumulator of kinetic energy, which can be used during braking, a hydraulic pump for a hydraulic-power steering circuit, and a vacuum pump for a circuit of the servo brake.

The epicyclic reduction gear 25 enables use of the engine 3 in its range of highest efficiency when it operates in conjunction with the internal-combustion engine 8 irrespective of the ratios of the speed change 10 used. The epicyclic reduction gear 25 moreover enables increase in the effectiveness of recovery of kinetic energy during braking, it being possible to increase the r.p.m. of the set of accessories 4 with respect to the end portion 12.

Finally, it is clear that modifications and variations may be made to the engine unit 1 described and illustrated herein without thereby departing from the scope of protection of the present invention, as defined in the annexed claims.

For example, in an embodiment that is less expensive, the transmission unit 7 is without said second speed change 25. In this case, if only the short ratio is envisaged, the second engine 3 may be used in parallel with the internal-combustion engine 8 only until its maximum r.p.m. is reached, beyond which it is turned off and disconnected by opening the clutch 23.

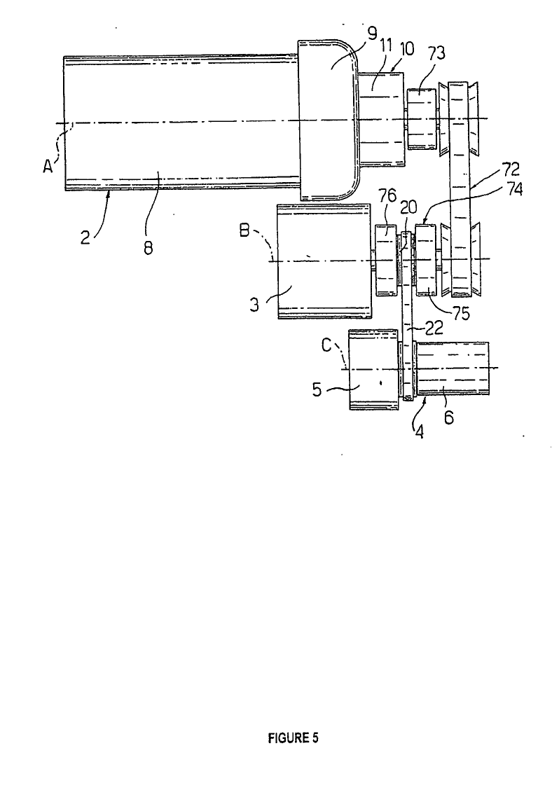

In a further embodiment, the transmission unit 7 comprises a transmission 72 (FIG. 5) with transmission ratio that can be varied with continuity according to an electronic control, said transmission 72 being connected to the end portion 12 of the engine set 2 via a servo clutch 73 to enable starting of the motor vehicle via the second engine 3 and change of gear of the speed change 10 and being connected to the crankshaft 13 of the second engine 3 via a decoupling assembly 74, which is functionally similar to the assembly 18. The decoupling assembly 74 coaxially comprises: the transmission pulley 20 for connection with the set of accessories 4; a first electromagnetic coupling 75 for connection of the transmission 72 to the transmission pulley 20; and a second electromagnetic coupling 76 for connection of the transmission pulley 20 to the crankshaft 13. In this case, the function of the epicyclic reduction gear 25 is performed by the transmission 72.

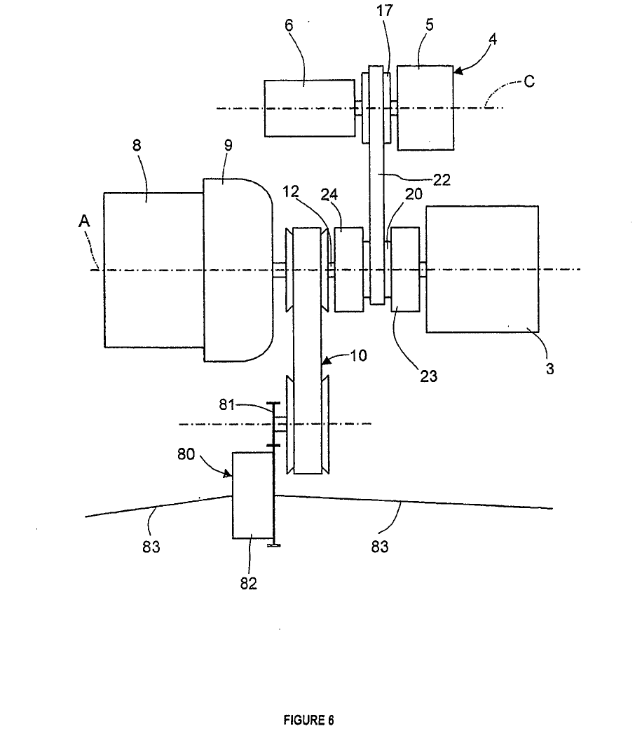

FIG. 6 represents a further embodiment, in which the engines 3 and 8 have reduced longitudinal overall dimensions, such as to enable them to be fitted so that they share the same axis A. Preferably, the speed change 10 has a transmission ratio that can vary with continuity according to an electronic control and comprises a primary shaft with axis A, which is connected directly on one side to the clutch 9 and on the other to the electromagnetic coupling 24 via the end portion 12.

Once again fitted so that they share the same axis A between the electromagnetic coupling 24 and the engine 3 are the pulley 20 that drives the set of accessories 4 and the servo clutch 23. The speed change 10 further comprises a secondary shaft, which turns at a variable speed with respect to the primary shaft and is connected to an assembly 80, which comprises a reduction gear 81, a differential 82, and axle shafts 83. This embodiment is particularly suitable for the production of small cars designed prevalently for urban transport. In addition, also in this case, as in the case of the robotized speed change described previously, the electronic control unit 90 controls the modes of operation of the speed change 10 and of the engine unit 1, recognizing the position of the accelerator.

Alternatively, the reversible electric machine 6 can be replaced by an alternator, by mounting a starting motor on the second engine 3, and, in this case, the clutch 23 can be centrifugal.

The centrifugal clutch enables automatic coupling of the second engine 3 to the transmission unit 7 as the r.p.m. of the second engine 3 increases, and decoupling is obtained by opening the electromagnetic coupling 24 for the time necessary to bring about reduction in the r.p.m. of the second engine 3 below a threshold for opening of the centrifugal clutch.

Alternatively, the accessories can be fitted so that they share the axis B, on a single drive shaft, which passes through each of them and is directly connected within the assembly 18 between the electromagnetic coupling 24, on one side, and the servo clutch 23, on the other.

In addition, the configuration illustrated in FIG. 1 can envisage that the electromagnetic coupling 24 will be mounted directly on the coupling portion 12 to maintain the loads on the synchronizer of the speed change 10 substantially unvaried during the operations of speed change made via the latter.

The electromagnetic couplings can be replaced by servo clutches.

In addition, the engine 3 can be supplied with gas fuel, for example methane or LPG, whilst the internal-combustion engine 8 can maintain the petrol or diesel supply. The use of an engine 3 supplied only with methane or LPG enables optimization thereof for the type of fuel used. Furthermore, the engine displacement is smaller than that of the internal-combustion engine 8, and it is hence possible to contain the dimensions and the weight of the tank for methane or LPG. When the engine 3 is supplied with methane or LPG, or is of an electric type, if the vehicle is travelling in areas allowed only for cars with reduced pollutant emission, it is possible to envisage inhibition of the internal-combustion engine 8, and a vehicle comprising the engine unit 1 can further comprise external signalling means, for example, ones using LEDs of an appropriate colour, in order to render the type of supply used visible to personnel responsible for traffic control, it being moreover possible to record each time the distance travelled after the last inhibition of the internal-combustion engine 8 in order to check that the distance travelled with the internal-combustion engine 8 inhibited is coherent with the distance from the perimeter of the area that requires inhibition.

1. An engine unit (1) with start-stop control for a motor vehicle, comprising:
an engine set (2), which has a first internal-combustion engine (8) having an output shaft rotatable about a first axis (A), a first servo clutch (9) rigidly connected to said output shaft of said first internal-combustion engine (8), and a first speed change (10) having a primary shaft connected to said first clutch (9) and to the wheels of said motor vehicle;
a set of accessories (4), which is driven by at least one driving shaft (14) rotatable about a second axis (C; B) and comprises at least one accessory from among: a compressor for an air-conditioning system (5), a vacuum pump for a servo-braking system, and a pump for a servo-steering system;
an electric machine (6);
said engine unit being characterized in that it comprises a transmission unit (7) for connecting together said first internal-combustion engine (8), said set of accessories (4), said electric machine (6), and a connecting portion (12), which is integral with said primary of said first speed change (10) to enable driving of said set of accessories (4) and said electric machine (6) by the wheels of said motor vehicle.

2. The engine unit according to claim 1, characterized in that said transmission unit (7) comprises first transmission means (16, 19, 21; 24; 72) for connecting said connecting portion (12) so that it turns about a third axis (B; F) parallel to said first axis (A), second transmission means (17, 20, 22) for connecting said third axis (B; F) to said driving shaft (14), and a decoupleable coupling (24) provided for decoupling said connecting portion (12) from said second transmission means (17, 20, 22) and in that said engine unit (1) comprises a second engine (3) connected to said second transmission means (17, 20, 22).

3. The engine unit according to claim 2, characterized in that said second engine (3) is an internal-combustion engine for propulsion, in that said transmission unit (7) comprises a second clutch (23) for decoupling said second engine (3) from said second transmission means (17, 20, 22), in that said set of accessories (4) comprises said electric machine (6) and in that said electric machine (6) is reversible.

4. The engine unit according to claim 2, characterized in that said electric machine is an alternator, in that said second clutch (23) is centrifugal, and in that said second engine (3) is provided with a starting motor.

5. The engine unit according to claim 2, characterized in that said second engine (3) is a reversible electric machine having a power smaller than or equal to that of said internal-combustion engine (8).

6. The engine unit according to any one of claims 2 to 5, characterized in that said transmission unit comprises a second speed change (25; 72) for connecting said first transmission means (16, 19, 21; 24; 72) and said second transmission means (17, 20, 22).

7. The engine unit according to claim 6, characterized in that at least one between said first speed change (10) and said second speed change (72) is an electronically controlled continuously variable transmission.

8. The engine unit according to claim 6, characterized in that said second engine (3) is set at a radial distance from said third axis (F) and in that said transmission unit (7) comprises a transmission (52), which is supported by supporting elements (51, 55) and comprises: a first sleeve (58), connected to said second transmission means (17, 20, 22); a second sleeve (54), connected to said second speed change (25) and coupled to said first sleeve (58) via said decoupleable coupling (24); a third sleeve (53), connected to said second engine (3) via transmission elements (62, 63) and to said first sleeve (58) via said second clutch (23); and a shaft (56), which is housed so that it can turn about said third axis (F) within said first, second and third sleeves (58, 53, 54) and is connected to said third sleeve (54) via said second speed change (25) and to said first transmission means (16, 19, 21).

9. The engine unit according to claim 6, characterized in that said second engine (3) is set at a radial distance from said third axis (F) and in that said transmission unit (7) comprises a transmission (52), which is supported by supporting elements (51, 55) and comprises: a first sleeve (58), which is connected to said second transmission means (17, 20, 22) and is coupled selectively to said second engine (3) via said second clutch (23) and via transmission elements (62, 63); a second sleeve (54), which is connected to said second speed change (25) and is coupled to said first sleeve (58) via said decoupleable coupling (24); and a shaft (56), which is housed so that it can turn about said third axis (F) within said first and second sleeves (54, 58) and connected to said second sleeve (54) via said second speed change (25) and to said first transmission means (16, 19, 21).

10. The engine unit according to any one of claims 2 to 7, characterized in that said third axis (B) and said first axis (A) coincide, in that said first and second engines (3, 8) are connected coaxially on opposite sides of said first speed change (10), and in that said first transmission means comprise said decoupleable coupling (24).

11. The engine unit according to any one of the preceding claims, characterized in that said connecting portion (12) comes out on the side opposite to said first servo clutch (9) with respect to said first speed change (10).

12. The engine unit according to any one of the preceding claims, characterized in that said set of accessories (4) further comprises a mechanical or fluid-dynamic assembly for accumulation of the kinetic energy.

13. The engine unit according to any one of the preceding claims, when depending upon claim 3, characterized in that said first internal-combustion engine (8) is designed to be connected to a supply circuit (29) comprising a fuel pump and in that said second engine (3) is designed to be branched to said supply circuit (29) downstream of said fuel pump.

14. The engine unit according to any one of the preceding claims, when depending upon claim 3, characterized in that said second engine (3) is supplied with fuel in the gaseous phase.

15. The engine unit according to any one of the preceding claims, when depending upon claim 3, characterized in that said first internal-combustion engine (8) is designed to be connected to an intake circuit (26) comprising an air filter (33) and in that said second engine (3) is designed to be connected to said intake circuit (26) by branching downstream of said filter (33).

16. The engine unit according to any one of the preceding claims, when depending upon claim 3, characterized in that said first internal-combustion engine (8) is designed to be connected to an exhaust circuit (27) comprising a catalytic converter (35), and in that said second engine (3) is designed to be connected to said exhaust circuit (27) by branching upstream of said catalytic converter (35).

17. The engine unit according to any one of the preceding claims, when depending upon claim 3, characterized in that said first internal-combustion engine (8) is designed to be connected to a cooling circuit (28) comprising: a radiator (37); an inlet line (36) provided with a pump (32) for conveying a cooling fluid from said radiator (37) to said first internal-combustion engine (8); and an outlet line (38), which is provided with a thermostat (39) and is designed to convey said cooling fluid from said internal-combustion engine (8) to said radiator (37), and in that said second engine (3) comprises a pump (41) designed to be branched to said inlet line (36) downstream of said radiator (37) via a first pipe (40) and further comprises a second thermostat (43) designed to be connected to said outlet line (38) upstream of said thermostat (39) via a second pipe (42).

18. The engine unit according to any one of the preceding claims, characterized in that, when said first clutch (9) is closed, said connecting portion (12) is rigidly connected to said drive shaft of said first internal-combustion engine (8).

19. The engine unit according to any one of the preceding claims, characterized in that it comprises an electronic control unit (90) designed to detect control signals coming at least from an accelerator pedal, from a brake pedal and from detection sensors connected to at least one from among a speedometer, a battery, an air-conditioning system, a braking system, a servo-steering system, an exhaust circuit, a cooling circuit for controlling turning-on and turning-off of said first internal-combustion engine (8), said first speed change (10), at least one between said first and second clutches (9, 23), and said decoupleable coupling (24).

20. A motor vehicle characterized in that it comprises an engine unit according to either claim 5 or claim 14 and in that it comprises means for signalling to the outside world de-activation of said first internal-combustion engine (8).

21. A method for controlling an engine unit according to any one of the preceding claims, characterized in that it comprises a step of releasing of an accelerator when said motor vehicle is in motion, in which said set of accessories (4) is rotationally connected to said first speed change (10) so as to be driven by the wheels of said motor vehicle, and said first internal-combustion engine (8) is turned off and decoupled from said first speed change (10).

22. The controlling method according to claim 21 for an engine unit according to any one of claims 1 to 19 when depending upon claim 2, characterized in that said set of accessories (4) is always driven when said second engine (3) is running and is rotationally connectable to said first speed change (10) so as to be driven when said second engine (3) is turned off.

23. The controlling method according to claim 21 for an engine unit according to any one of claims 1 to 19, characterized in that during a reverse motion step only said first internal-combustion engine (8) is used.

24. The controlling method according to claim 21 for an engine unit according to any one of claims 1 to the 19, characterized in that a pickup step subsequent to a reverse motion step is performed using just the first internal-combustion engine (8).

25. The controlling method according to claim 21 for an engine unit according to any one of claims 1 to 19 when depending upon claim 6, characterized in that said first and second speed changes (10, 25; 72) are selected in a transmission ratio such that the r.p.m. of said driving shaft (14) is always the maximum one possible and lower than the maximum r.p.m. allowed for said set of accessories (4).

26. The controlling method according to claim 21 for an engine unit according to any one of claims 1 to 19, when depending upon claim 6, characterized in that said first and second speed changes (10, 25; 72) are selected in a transmission ratio such that the r.p.m. of said second engine (3) is always lower than the maximum r.p.m. and such as to maximize the efficiency of said second engine (3).

27. The controlling method according to claim 21 for an engine unit according to any one of claims 1 to 19, when depending upon claim 2, characterized in that, when said accelerator is released with said motor vehicle in motion, both of said first and second engines (8, 3) are disconnected automatically from said transmission unit (7) and stopped.

28. The controlling method according to claim 21 for an engine unit according to any one of claims 1 to 19, when depending upon claim 2, characterized in that, if said set of accessories (4) is not to be actuated, said set of accessories (4) is disconnected from said transmission unit (7) and free-wheeling is provided.

29. The controlling method according to claim 21 for an engine unit according to any one of claims 1 to 19, characterized in that, during a braking step, according to the deceleration required, said set of accessories (4) and at least one between said first and second engines (8, 3) are engaged in sequence and then the brakes are activated.

30. The controlling method according to claim 21 for an engine unit according to any one of claims 1 to 19, characterized in that at least one between said first internal-combustion engine (8) and second engine (3) is started via said transmission unit (7) using the inertia of said vehicle.

31. The controlling method according to claim 21 for an engine unit according to any one of claims 1 to 19, when depending upon claim 2, characterized in that, if at pickup of said motor vehicle a maximum performance is required, a fast starting sequence is implemented, which comprises: a step of starting of said second engine (3); a subsequent step, in which said second engine (3) starts said first internal-combustion engine (8) when said first speed change (10) is in neutral; and a step of pickup of the motor vehicle via said first and second coupled engines (8, 3).

32. The controlling method according to claim 21 for an engine unit according to any one of claims 1 to 19, when depending upon either claim 5 or claim 14, characterized in that it comprises a step of storage of the number of kilometres travelled when only said second engine (3) is turned on.
